(19) United States
(12) Patent Application Publication
(10) Pub. No.: US 2014/0141340 A1
(43) Pub. Date: May 22, 2014

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO. LTD., Yongin-si (KR)

(72) Inventors: Vladimir Egorov, Yongin-si (KR); Woo-Cheol Shin, Yongin-si (KR); Pavel Alexandrovich Shatunov, Yongin-si (KR)

(73) Assignee: SAMSUNG SDI CO., LTD., Yongin-si (KR)

(21) Appl. No.: 13/783,090

(22) Filed: Mar. 1, 2013

Related U.S. Application Data
(60) Provisional application No. 61/728,432, filed on Nov. 20, 2012.

(51) Int. Cl. H01M 10/056; H01M 10/058; H01M 10/0565

(52) U.S. Cl. CPC H01M 10/056; H01M 10/0565; H01M 10/058
USPC 429/310; 429/336; 429/339; 429/340; 429/341; 29/623.5

(57) ABSTRACT

An electrolyte for a rechargeable lithium battery that includes a lithium salt and a non-aqueous organic solvent including a compound represented by the following Chemical Formula 1 is described:

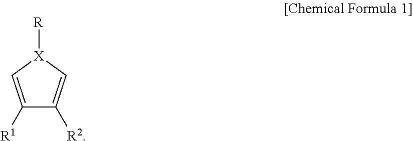

The compound represented by Chemical Formula 1 is included at greater than or equal to 0.001 volume % and less than 1 volume % based on a total volume of the non-aqueous organic solvent. A rechargeable lithium battery including the electrolyte is also described.

### CROSS-REFERENCE TO RELATED APPLICATION

This application claims priority to and the benefit of U.S. Provisional Application No. 61/728,432, filed on Nov. 20, 2012 in the U.S. Patent and Trademark Office, the entire content of which is incorporated herein by reference.

### BACKGROUND

(a) Field

This disclosure relates to an electrolyte for a rechargeable lithium battery, and a rechargeable lithium battery including the same.

(b) Description of the Related Art

Batteries transform chemical energy generated from an electrochemical redox reaction of a chemical material into electrical energy. Batteries may be divided into a primary battery, which is typically discarded after consuming all or substantially all of the energy, and a rechargeable battery, which can be recharged. The rechargeable battery can be charged/discharged based on a reversible transformation between chemical energy and electrical energy. Recent developments in the electronic industry has allowed an electronic device to become smaller and lighter in weight, which leads to more uses of portable electronic devices. It is generally desirable to have portable electronic devices that are powered by rechargeable batteries with high energy densities.

A rechargeable lithium battery typically includes an electrolyte in a battery cell. The battery cell typically includes a positive electrode including a positive active material that can intercalate and deintercalate lithium, and a negative electrode including a negative active material that can intercalate and deintercalate lithium. The electrolyte, which generally uses an organic solvent with a dissolved lithium salt, may be important to determine the stability and performance of a rechargeable lithium battery. Here stability may be even more important in a high-capacity rechargeable lithium battery.

### SUMMARY OF THE INVENTION

An aspect of an embodiment of the present invention provides an electrolyte for a rechargeable lithium battery having improved cycle-life characteristics, storage characteristics, and/or stability. Another aspect of an embodiment of the present invention provides a rechargeable lithium battery including the above-mentioned electrolyte. The electrolyte for the rechargeable lithium battery according to some embodiments, includes a lithium salt and a non-aqueous organic solvent, the non-aqueous organic solvent including a compound represented by the following Chemical Formula 1, wherein the compound represented by the above Chemical Formula 1 is included at greater than or equal to 0.001 volume % and less than 1 volume %, or greater than or equal to 0.05 volume % and less than 1 volume %, based on a total volume of the non-aqueous organic solvent:

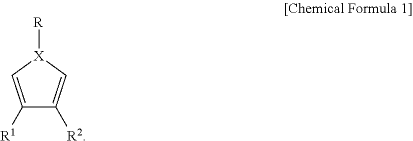

In Chemical Formula 1,

X is nitrogen (N) or sulfur (S);

R¹ and R² are each independently selected from the group consisting of hydrogen (H), a halogen, a cyano group (CN), a nitro group (NO₂), a substituted or unsubstituted C1 to C30 alkyl group, a substituted or unsubstituted C3 to C30 cycloalkyl group, a substituted or unsubstituted C6 to C30 aryl group, a substituted or unsubstituted C2 to C30 alkenyl group, a substituted or unsubstituted C3 to C30 cycloalkenyl group, a substituted or unsubstituted C2 to C30 alkynyl group, a substituted or unsubstituted C3 to C30 cycloalkynyl group, a substituted or unsubstituted C2 to C30 heterocycloalkyl group, a substituted or unsubstituted C2 to C30 heteroaryl group, a substituted or unsubstituted C1 to C30 alkoxy group, or an aldehyde group;

R is selected from the group consisting of a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C20 arylalkyl group, a substituted or unsubstituted C2 to C30 alkenyl group, a substituted or unsubstituted C3 to C30 cycloalkenyl group, a substituted or unsubstituted C2 to C30 alkynyl group, a substituted or unsubstituted C1 to C20 heteroalkyl group, a substituted or unsubstituted C2 to C30 heterocycloalkyl group, a substituted or unsubstituted C2 to C30 heteroaryl group, —SiR³₃, —NR⁴R⁵, or —PR⁶R⁷; and

R³, R⁴, R⁵, R⁶, and R⁷ are each independently selected from the group consisting of a substituted or unsubstituted C1 to C30 alkyl group, a substituted or unsubstituted C3 to C30 cycloalkyl group, a substituted or unsubstituted C2 to C30 alkenyl group, or a C6 to C30 substituted or unsubstituted aryl group.

In some embodiments, the electrolyte does not include a halogen (X′) of the form X′₂ or HX′. In some embodiments, the electrolyte further does not include a halogen-containing compound other than that as represented by Chemical Formula 1.

In some embodiments, in Chemical Formula 1, R is a substituted or unsubstituted C6 to C30 aryl group or SiR³₃ (wherein R³ is a substituted or unsubstituted C1 to C30 alkyl group, a substituted or unsubstituted C3 to C30 cycloalkyl group, a substituted or unsubstituted C2 to C30 alkenyl group, or C6 to C30 substituted or unsubstituted aryl group).

Another embodiment of the present invention provides a rechargeable lithium battery that includes a positive electrode including a positive active material, a negative electrode including a negative active material, and the electrolyte. According to embodiments herein described, the rechargeable lithium battery may further include a SEI (solid electrolyte interphase) passivation film formed on the surface of positive electrode. The SEI passivation film may include a polymer represented by the following Chemical Formula 2:

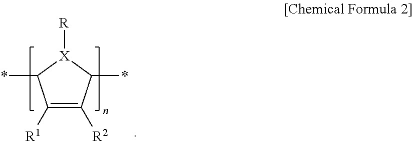

In Chemical Formula 2,

X, R¹, R², and R are the same as in the above Chemical Formula 1, and

n is an integer of 2 to 1000.

The positive active material may include a compound represented by the following Chemical Formula 3, a compound represented by the following Chemical Formula 4, or a combination thereof.

(P)Li₂MnO₃.(1-P)LiNiₐCo_{b}Mn_{c}O₂ [Chemical Formula 3]

In Chemical Formula 3, 0.25<P<0.75, 0.25<a<0.75, 0.1<b<0.5, 0.1<c<0.5, and a+b+c=1.

Li_{d}NiₓCo_{y}Mn_{1-x-y}O₂ [Chemical Formula 4]

In Chemical Formula 4, 0.9≦d<1.1, 0.3≦x≦0.75, and 0.15≦y≦0.4.

A rechargeable lithium battery according to embodiments of the present invention may have improved stability, cycle-life characteristics, and/or storage characteristics.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic view of a rechargeable lithium battery according to one embodiment.

FIG. 2 is a LSV (linear sweep voltammetry) graph of the rechargeable lithium batteries obtained from Example 1 and Comparative Example 1.

FIG. 3 is a graph showing a capacity retention as a function of cycle number, for the rechargeable lithium batteries obtained from Example 1, Example 2, and Comparative Example 1.

FIG. 4 is a graph showing a capacity as a function of cycle number, for the rechargeable lithium batteries obtained from Example 3 and Comparative Example 2.

FIG. 5 is a graph showing a capacity retention as a function of cycle number, for the rechargeable lithium batteries obtained from Example 1, Example 2, and Comparative Example 1, after being allowed to stand for 20 days.

FIG. 6 is a graph showing a coulomb efficiency as a function of cycle number, for the rechargeable lithium batteries obtained from Example 3 and Comparative Example 2.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when a first element is referred to as being “on” a second element, it can be directly on the second element or be indirectly on the second element with one or more intervening elements interposed therebetween. Like reference numerals designate like elements throughout the specification.

As used herein, unless indicated otherwise, the term “substituted” may refer to substitution of a hydrogen with at least one substituent such as a halogen (F, Br, Cl, or I), a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C7 to C30 arylalkyl group, a C1 to C4 alkoxy group, a C1 to C20 heteroan alkyl group, a C3 to C20 heteroarylalkyl group, a C3 to C30 cycloalkyl group, a C3 to C15 cycloalkenyl group, a C6 to C15 cycloalkynyl group, a C2 to C20 heterocycloalkyl group, or a combination thereof.

An electrolyte for a rechargeable lithium battery according to one embodiment includes a lithium salt and a non-aqueous organic solvent. The non-aqueous organic solvent may include a compound represented by the following Chemical Formula 1:

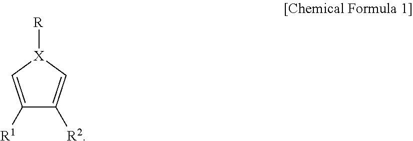

In Chemical Formula 1,

X is nitrogen (N) or sulfur (S),

R¹ and R² are each independently selected from the group consisting of hydrogen (H), a halogen, a cyano group (CN), a nitro group NO₂, a substituted or unsubstituted C1 to C30 alkyl group, a substituted or unsubstituted C3 to C30 cycloalkyl group, a substituted or unsubstituted C6 to C30 aryl group, a substituted or unsubstituted C2 to C30 alkenyl group, a substituted or unsubstituted C3 to C30 cycloalkenyl group, a substituted or unsubstituted C2 to C30 alkynyl group, a substituted or unsubstituted C3 to C30 cycloalkynyl group, a substituted or unsubstituted C2 to C30 heterocycloalkyl group, a substituted or unsubstituted C2 to C30 heteroaryl group, a substituted or unsubstituted C1 to C30 alkoxy group, or an aldehyde group,

R is an unsubstituted C1 to C30 alkyl group, a substituted or unsubstituted C3 to C30 cycloalkyl group, a substituted or unsubstituted C6 to C30 aryl group, a substituted or unsubstituted C7 to C20 arylalkyl group, a substituted or unsubstituted C2 to C30 alkenyl group, a substituted or unsubstituted C3 to C30 cycloalkenyl group, a substituted or unsubstituted C2 to C30 alkynyl group, a substituted or unsubstituted C1 to C20 heteroalkyl group, a substituted or unsubstituted C2 to C30 heterocycloalkyl group, a substituted or unsubstituted C2 to C30 heteroaryl group, —SiR³₃, —NR⁴R⁵, or —PR⁶R⁷, wherein R³, R⁴, R⁵, R⁶ and R⁷ are each independently a substituted or unsubstituted C1 to C30 alkyl group, a substituted or unsubstituted C3 to C30 cycloalkyl group, a substituted or unsubstituted C2 to C30 alkenyl group, or a C6 to C30 substituted or unsubstituted aryl group.

In some embodiments, the electrolyte does not include a halogen (X′) of the form X′₂ or HX′ (e.g. F₂, Cl₂, I₂ or HF, HCl, HI). In some embodiments, the electrolyte further does not include a halogen-containing compound other than that as represented by Chemical Formula 1.

In the above Chemical Formula 1, according to some embodiments, X is preferably nitrogen (N).

In the above Chemical Formula 1, according to some embodiments, R is preferably a substituted or unsubstituted C6 to C30 aryl group or SiR³₃ (wherein R³ is a substituted or unsubstituted C1 to C30 alkyl group, a substituted or unsubstituted C3 to C30 cycloalkyl group, a substituted or unsubstituted C2 to C30 alkenyl group, or C6 to 030 substituted or unsubstituted aryl group.).

In embodiments wherein R is the substituted or unsubstituted C6 to C30 aryl group or the SiR³₃, the monomers represented by Chemical Formula 1 may be particularly effective for polymerization to provide a polymer represented by the following Chemical Formula 2. The polymer represented by the following Chemical Formula 2 may form a SEI passivation film on the surface of a positive electrode:

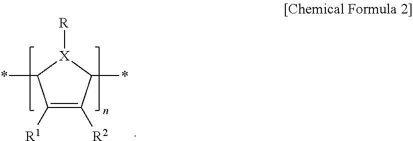

In Chemical Formula 2,

X, R¹, R² and R may be the same as in the above Chemical Formula 1, and

n is an integer of 2 to 1000.

According to some embodiments, by adjusting an amount of the compound represented by Chemical Formula 1 to be included in the electrolyte, the rechargeable lithium battery may have improved stability, cycle-life characteristics, and/or storage characteristics.

In some embodiments, the compound represented by Chemical Formula 1 may be included in the electrolyte at greater than or equal to 0.001 volume % and less than 1 volume %, based on a total volume of the non-aqueous organic solvent. In some embodiments, the compound represented by Chemical Formula 1 is preferably included in the electrolyte at greater than or equal to 0.05 volume % and less than 1 volume %, based on a total volume of the non-aqueous organic solvent.

In embodiments where the compound represented by Chemical Formula 1 is included in the electrolyte within the above-mentioned ranges, lithium ions are effectively intercalated and deintercalated, which may improve cycle-life characteristics, storage characteristics, and/or stability of the rechargeable lithium battery.

The non-aqueous organic solvent may include an organic solvent, further to the compounds represented by the above Chemical Formula 1.

The organic solvent may include, but is not limited to one or more of a carbonate-based, an ester-based, an ether-based, a ketone-based, an alcohol-based, and an aprotic solvent.

The carbonate-based solvent may include, but is not limited to one or more of dimethylcarbonate (DMC), diethylcarbonate (DEC), dipropylcarbonate (DPC), methylpropylcarbonate (MPC), ethylpropylcarbonate (EPC), ethylmethylcarbonate (EMC), ethylenecarbonate (EC), propylenecarbonate (PC), butylenecarbonate (BC), and the like.

The ester-based solvent may include, but is not limited to one or more of methyl acetate, ethyl acetate, n-propyl acetate, 1,1-dimethylethyl acetate, methylpropinonate, ethylpropinonate, γ-butyrolactone, decanolide, valerolactone, mevalonolactone, caprolactone, and the like.

The ether-based solvent may include, but is not limited to one or more of dimethyl ether, dibutyl ether, tetraglyme, diglyme, dimethoxyethane, 2-methyltetrahydrofuran, tetrahydrofuran (THF), and the like.

The ketone-based solvent may include, but is not limited to cyclohexanone, the like, or a mixture thereof.

The alcohol-based solvent may include, but is not limited to one or more of ethanol, isopropylalcohol, and the like.

The aprotic solvent may include, but is not limited to one or more of nitriles such as R—CN (wherein R is a C2 to C20 linear, branched, or cyclic hydrocarbon, and may include one or more double bonds, one or more aromatic rings, and/or one or more ether bonds); amides such as dimethylformamide or dimethylacetamide; dioxolanes such as 1,3-dioxolane; sulfolanes; and the like.

The organic solvent may be used singularly or in a mixture. In embodiments where the organic solvent is used in a mixture, a mixture ratio can be controlled in accordance with a desired performance of a battery.

In embodiments where one or more of a carbonate-solvent is used, the carbonate-based solvent may include a mixture of a cyclic carbonate and a linear carbonate. In some embodiments, the cyclic carbonate and the linear carbonate are mixed together in a volume ratio of about 1:1 to about 1:9 and the electrolyte may have enhanced performance.

In some embodiments, the non-aqueous organic solvent further includes an aromatic hydrocarbon-based organic solvent in addition to the carbonate-based solvent. In some of these embodiments, the carbonate-based solvent and the aromatic hydrocarbon-based solvent are mixed together in a volume ratio of about 1:1 to about 30:1.

The aromatic hydrocarbon-based organic solvent may be selected from the group consisting of benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof, but is not limited thereto.

According to some embodiments, the lithium salt may be dissolved in the non-aqueous solvent. The non-aqueous solvent including the lithium salt may supply lithium ions to operate the rechargeable lithium battery and may improve lithium ion transfer between positive and negative electrodes. According to some embodiments, the lithium salt may include, but is not limited to one or more of a salt selected from LiPF₆, LiBF₄, LiSbF₆, LiAsF₆, LiN (SO₂C₂F₅)₂, Li(CF₃SO₂)₂N, LiN (SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (wherein x and y are non-zero natural numbers), LiCl, and LiI.

In some embodiments, the lithium salt may be used in a concentration of about 0.1 to about 2.0M. In embodiments where the lithium salt is included within the above concentration range, the electrolyte may have improved performance and lithium ion mobility due to optimal electrolyte conductivity and viscosity.

In some embodiments, the electrolyte may further include an additive such as lithium bis(oxalato)borate (LiBOB), lithium bis(salicylato)borate (LiBSB), or a combination thereof. In embodiments where a lithium bis(oxalato)borate (LiBOB) and/or lithium bis(salicylato)borate (LiBSB) additive is used, thermal stability of an electrolyte and cycle performance of a battery may be improved.

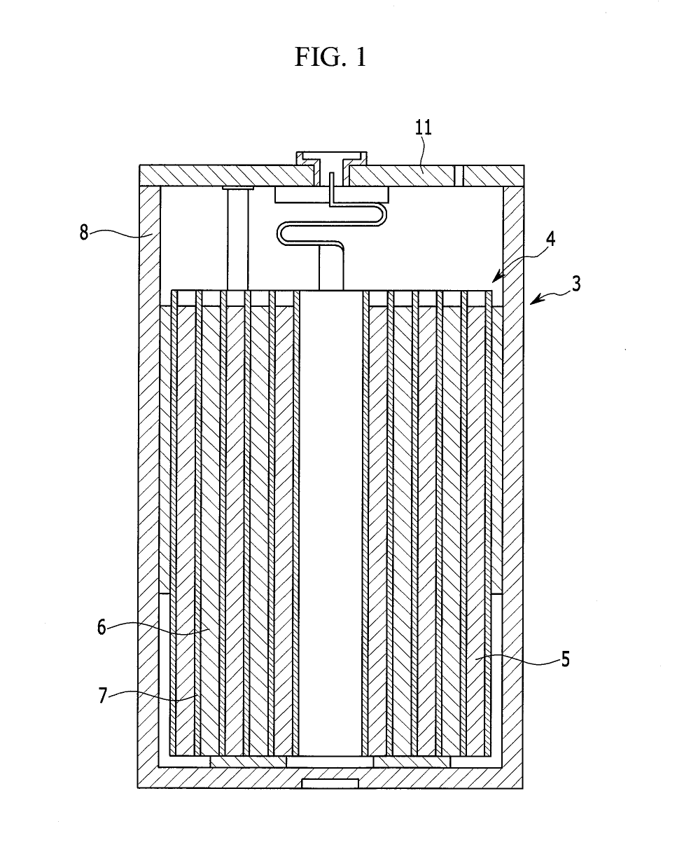

A rechargeable lithium battery including an electrolyte is now described by way of example, and not of limitation, referring to the embodiment schematically exemplified FIG. 1.

FIG. 1 shows a schematic view of a rechargeable lithium battery according to one embodiment.

Referring to FIG. 1, a rechargeable lithium battery 3 according to an embodiment is a prismatic battery including an electrode assembly 4, the electrode assembly including a positive electrode 5, a negative electrode 6, and a separator 7 interposed between the positive electrode 5 and the negative electrode 6, in a battery case 8; an electrolyte injected from an upper part; and a cap plate 11 sealing the battery. The rechargeable lithium battery according to embodiments herein described is in no way limited to a prismatic battery and may include other operable batteries. For example, the rechargeable lithium battery may be a cylindrical, coin-type, or pouch battery.

The positive electrode 5 may include a current collector and a positive active material layer disposed on the current collector.

The current collector may include Al, but is not limited thereto.

The positive active material layer may include a positive active material, a binder, and optionally a conductive material.

The positive active material may include one or more compounds that can reversibly intercalate and deintercalate lithium ions, herein also referred to as “lithiated intercalation compounds”. In some embodiments, the positive active material may include a composite oxide such as cobalt, manganese, nickel or combination thereof, as well as lithium. In some embodiments, the positive active material may include one or more compounds represented by the following chemical formulae: LiₐA_{1-b}R_{b}D₂ (wherein, in the above chemical formula, 0.90≦a≦1.8 and 0≦b≦0.5); LiₐE_{1-b}R_{b}O_{2-c}D_{c} (wherein, in the above chemical formula, 0.90≦a≦1.8, 0≦b≦0.5 and 0≦c≦0.05); LiE_{2-b}R_{b}O_{4-c}D_{c} (wherein, in the above chemical formula, 0≦b≦0.5, 0≦c≦0.05); LiₐNi_{1-b-c}Co_{b}R_{c}D_{α} (wherein, in the above chemical formula, 0.90≦a≦1.8, 0≦b≦0.5, 0≦c≦0.05 and 0<α≦2); LiₐNi_{1-b-c}Co_{b}R_{c}O_{2-α}Z_{α} (wherein, in the above chemical formula, 0.90≦a≦1.8, 0≦b≦0.5, 0≦c≦0.05 and 0<α<2); LiₐNi_{1-b-c}Co_{b}R_{c}O_{2-α}Z₂ (wherein, in the above chemical formula, 0.90≦a≦1.8, 0≦b≦0.5, 0≦c≦0.05 and 0<α<2); LiₐNi_{1-b-c}Mn_{b}R_{c}D_{α} (wherein, in the above chemical formula, 0.90≦a≦1.8, 0≦b≦0.5, 0≦c≦0.05 and 0<α≦2); LiₐNi_{1-b-c}Mn_{b}R_{c}O_{2-α}Z_{α} (wherein, in the above chemical formula, 0.90≦a≦1.8, 0≦b≦0.5, 0≦c≦0.05 and 0<α<2); LiₐNi_{1-b-c}Mn_{b}R_{c}O_{2-α}Z₂ (wherein, in the above chemical formula, 0.90≦a≦1.8, 0≦b≦0.5, 0≦c≦0.05 and 0<α<2); LiₐNi_{b}E_{c}G_{d}O₂ (wherein, in the above chemical formula, 0.90≦a≦1.8, 0≦b≦0.9, 0≦c≦0.5 and 0.001≦d≦0.1); LiₐNi_{b}Co_{c}Mn_{d}GₑO₂ (wherein, in the above chemical formula, 0.90≦a≦1.8, 0≦b≦0.9, 0≦c≦0.5, 0≦d≦0.5 and 0.001≦e≦0.1); LiₐNiG_{b}O₂ (wherein, in the above chemical formula, 0.90≦a≦1.8 and 0.001≦b≦0.1); LiₐCoG_{b}O₂ (wherein, in the above chemical formula, 0.90≦a≦1.8 and 0.001≦b≦0.1); LiₐMnG_{b}O₂ (wherein, in the above chemical formula, 0.90≦a≦1.8 and 0.001≦b≦0.1); LiₐMn₂G_{b}O₄ (wherein, in the above chemical formula, 0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃(0≦f≦2); Li_{(3-f)}Fe₂(PO₄)₃(0≦f≦2); and LiFePO₄.

In the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

The compounds may have a coating layer on the surface, or can be mixed with compounds having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compounds for a coating layer may be amorphous or crystalline. The coating element for a coating layer may include, but is not limited to Mg, Al, Co, K, Na, Ca, Si, Ti, V, Sn, Ge, Ga, B, As, Zr, or a mixture thereof. The coating layer may be formed using a method having no negative influence or substantially no negative influence on properties of a positive active material by including such elements. For example, the method may include a coating method such as spray coating, dipping, and the like. Such methods are not illustrated in more detail as they are well-known to those skilled in the art.

According to some embodiments, the positive active material may include a compound represented by the following Chemical Formula 3, a compound represented by the following Chemical Formula 4, or a combination thereof.

(P)Li₂MnO₃.(1-P)LiNiₐCo_{b}Mn_{c}O₂. [Chemical Formula 3]

In Chemical Formula 3, 0<P<1, 0<a<1, 0<b<1, 0<c<1, and a+b+c=1.

Li_{d}NiₓCo_{y}Mn_{1-x-y}O₂. [Chemical Formula 4]

In Chemical Formula 4, 0.9≦d<1.1, 0.3≦x≦0.75, and 0.15≦y≦3.4.

When the rechargeable lithium battery according to one embodiment includes at least one of the above-mentioned positive active materials, the rechargeable lithium battery may have further improved capacity characteristics.

The binder may improve binding properties of the positive active material particles to each other and to a current collector. Exemplary binders include polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like, but are not limited thereto.

The conductive material may improve electrical conductivity of a positive electrode. Suitable conductive materials include electrically conductive materials which can be used as a conductive agent and which avoid or substantially avoid causing a chemical change. Exemplary conductive materials include, but are not limited to natural graphite; artificial graphite; carbon black; acetylene black; ketjen black; a carbon fiber; a metal powder, metal fiber or the like including metals such as copper, nickel, aluminum, silver or the like; a polyphenylene derivative, or the like; or a mixture thereof.

The positive electrode may be manufactured by a method including mixing the positive active material, the conductive material, and the binder in a solvent to prepare a positive active material composition, and coating the composition on the current collector. The solvent may include N-methylpyrrolidone and the like, but is not limited thereto. Methods of manufacturing a positive electrode are well known, and thus are not described in more detail in the present specification.

According to one embodiment, a SEI (solid electrolyte interphase) passivation film may be formed on a surface of a positive electrode.

The non-aqueous organic solvent according to embodiments herein described may include a compound represented by Chemical Formula 1, and the compounds represented by the above Chemical Formula 1 may be polymerized to provide a polymer. The polymer may form a SEI passivation film by forming a coating layer on the surface of an electrode in a rechargeable lithium battery, particularly on a positive electrode. Such a rechargeable lithium battery may have improved electrochemical performance, for example, by preventing or reducing a side reaction between a positive active material and an electrolyte solution.

The SEI (solid electrolyte interphase) passivation film may include a polymer represented by the following Chemical Formula 2.

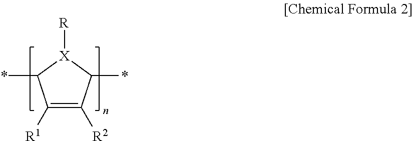

In Chemical Formula 2,

X, R¹, R², and R are the same as in the above Chemical Formula 1, and

n is an integer of 2 to 1000.

The negative electrode 6 may include a negative current collector and a negative active material layer disposed on the negative current collector.

The negative current collector may be, for example, a copper foil, but is not limited thereto.

The negative active material layer may include a negative active material, a binder, and optionally a conductive material.

The negative active material may include a material that reversibly intercalates/deintercalates lithium ions, a lithium metal, a lithium metal alloy, a material being capable of doping lithium, or a transition metal oxide.

The material that reversibly intercalates/deintercalates lithium ions may include carbon materials. The carbon material may include a carbon-based negative active material which is generally used in lithium ion secondary batteries. Exemplary carbon-based materials include, but are not limited to crystalline carbon, amorphous carbon, and a combination thereof. The crystalline carbon may be non-shaped or shaped (e.g. sheet, flake, spherical, or fiber shaped) natural graphite or artificial graphite. The amorphous carbon may be a soft carbon (e.g. carbon obtained by sintering at a low temperature), a hard carbon (e.g. carbon obtained by sintering at a high temperature), a mesophase pitch carbonized product, fired coke, and the like.

The lithium metal alloy may be an alloy including lithium and a metal selected from Na, K, Rb, Cs, Fr, Be, Mg, Ca, Sr, Si, Sb, Pb, In, Zn, Ba, Ra, Ge, Al, or Sn.

The material capable of doping and dedoping lithium may include Si, SiOₓ (0<x<2), a Si—C composite, a Si-Q alloy (wherein Q is an alkali metal, an alkaline-earth metal, a Group 13 to 16 element excluding Si, a transition element, a rare earth element, or a combination thereof), Sn, SnO₂, a Sn—C composite, an Sn—R alloy (wherein R is an alkali metal, an alkaline-earth metal, a Group 13 to 16 element excluding Sn, a transition element, a rare earth element, or a combination thereof), and the like. Q and R may include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The transition metal oxide may include vanadium oxide, lithium vanadium oxide, or the like.

The binder may improve binding properties of the negative active material particles to each other and to a current collector. Exemplary binders include polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material may improve electrical conductivity of a negative electrode. Suitable conductive materials include electrically conductive materials which can be used as a conductive agent and which avoid or substantially avoid causing a chemical change. Exemplary conductive material include, but are not limited to carbon-based materials of natural graphite or artificial graphite; carbon black, acetylene black, ketjen black, a carbon fiber, or the like; a metal-based material of a metal powder or a metal fiber including copper, nickel, aluminum, silver, or the like; a conductive polymer such as a polyphenylene; or a mixture thereof.

The negative electrode may be manufactured by a method including mixing the negative active material, the conductive material and the binder in a solvent to prepare a negative active material composition, and coating the negative active material composition on a current collector. The solvent may include N-methylpyrrolidone and the like, but is not limited thereto. Such electrode-manufacturing methods are well known, and thus are not described in more detail in the present specification.

The separator 7 may include materials used in a conventional lithium battery, which are suitable for separating a negative electrode from a positive electrode and providing a passage for transporting lithium ions. A suitable separator may have a low resistance to ion transportation and is capable of being impregnated with an electrolyte. For example, the separator 7 may include materials selected from glass fiber, polyester, TEFLON (tetrafluoroethylne), polyethylene, polypropylene, polytetrafluoroethylene (PTFE), or a combination thereof. The above-mentioned materials may be in a form of a non-woven fabric or a woven fabric. The separator 7 may be a polyolefin-based polymer separator including polymers such as polyethylene, polypropylene, or the like.

In order to improve heat resistance and/or mechanical strength, a coated separator including a ceramic component or a polymer material may be used. Thus the separator may have a mono-layered or multi-layered structure.

Rechargeable lithium batteries (also referred to as “lithium secondary batteries”) may be classified into lithium ion batteries, lithium ion polymer batteries, and lithium polymer batteries, based on whether or not a separator is used and based on the kind of electrolyte used in the battery. Lithium secondary batteries according to embodiments of the present disclosure may have a variety of shapes and sizes, including, for example, having a cylindrical, a prismatic, or a coin-shape, and may be thin film batteries, or bulky batteries in size. Structures and fabrication methods for lithium ion batteries are well known in the art.

The electrolyte in the rechargeable lithium batteries may be the same as described above in accordance with embodiments of the present disclosure.

The following examples serve to illustrate the present invention in more detail. These examples, however, should not in any sense be interpreted as limiting the scope of the present invention.

A person having ordinary skill in the art will understand features of the present invention which may not be explicitly described.

### Example 1

A positive active material of LiNi₅Co₂Mn₃O₂, a binder of SOLEF® 6020 PVDF, and a conductive material of Denka Black were mixed at a weight ratio of 92:4:4 and dispersed in N-methyl-2-pyrrolidone to provide a positive electrode slurry. The positive electrode slurry was coated on an aluminum foil and dried and compressed to obtain a positive electrode.

A negative active material of graphite coated with alumina, a binder of SOLEF® 6020 PVDF, and a conductive material of Denka Black were mixed at a weight ratio of 92:4:4 and dispersed in N-methyl-2-pyrrolidone to provide a negative electrode slurry. The negative electrode slurry was coated on a copper foil and dried and compressed to obtain a negative electrode.

An electrolyte solution was obtained by dissolving 1.3 mol. of LiPF₆ lithium salt per liter of a non-aqueous organic solvent, the non-aqueous organic solvent including 99.9 volume % of carbonate-based solvent including a mixture of ethylene carbonate (EC), ethylmethyl carbonate (EMC), and dimethyl carbonate (DMC) in a volume ratio of 3:4:3, and 0.1 volume % of N-phenylpyrrole, to provide a 1.3M concentration of LiPF₆ in the electrolyte solution.

Using the obtained positive electrode, the obtained negative electrode, the obtained electrolyte solution, and a Celgard 2320 separator, a rechargeable lithium battery cell was fabricated.

### Example 2

A rechargeable lithium battery cell was fabricated according to Example 1, except that 99.5 volume % of carbonate-based solvent with 0.5 volume % of N-phenylpyrrole was used.

### Example 3

A rechargeable lithium battery cell was fabricated according to Example 1, except that Li₂MnO₃ was used as the positive active material.

### Example 4

A rechargeable lithium battery cell was fabricated according to Example 1, except that 99.999 volume % of carbonate-based solvent with 0.001 volume % of N-phenylpyrrole was used.

### Example 5

A rechargeable lithium battery cell was fabricated according to Example 1, except that 99.99 volume % of carbonate-based solvent with 0.01 volume % of N-phenylpyrrole was used.

### Comparative Example 1

A rechargeable lithium battery cell was fabricated according to Example 1, except that the electrolyte solution was prepared without N-phenylpyrrole.

### Comparative Example 2

A rechargeable lithium battery cell was fabricated according to Example 3, except that the electrolyte solution was prepared without adding N-phenylpyrrole.

### Comparative Example 3

A rechargeable lithium battery cell was fabricated according to Example 1, except that 99 volume % of carbonate-based solvent with 1 volume % of N-phenylpyrrole was used.

Evaluation 1: Electrochemical Stability Evaluation of Rechargeable Lithium Battery Cells

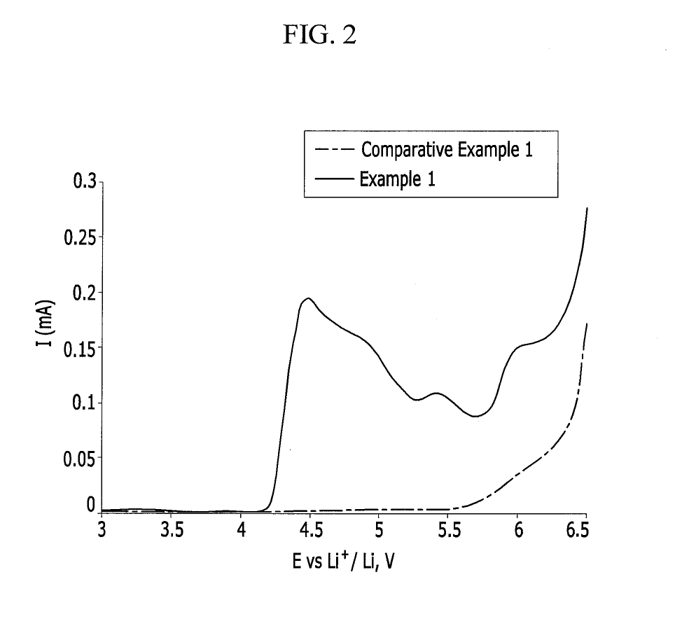

The rechargeable lithium battery cells according to Example 1 and Comparative Example 1 were evaluated using LSV (linear sweep voltammetry), and the results are shown in FIG. 2.

FIG. 2 is a LSV (linear sweep voltammetry) graph of rechargeable lithium battery cells according to Example 1 and Comparative Example 1.

FIG. 2 shows that the rechargeable lithium battery cell according to Example 1 including the non-aqueous organic solvent and the compound represented by Chemical Formula 1 in an amount according to embodiments herein described, increased the oxidation peak around 4.5V higher than the rechargeable lithium battery cell according to Comparative Example 1. Comparative Example 1 included the non-aqueous organic solvent but did not include a compound represented by Chemical Formula 1. This shows that the compound represented by Chemical Formula 1 was first decomposed at a positive electrode to provide a coating layer on the positive electrode before decomposing the solvent.

From these results, it may be understood that the electrolyte for a rechargeable lithium battery cell according to Example 1, including the compound represented by Chemical Formula 1, had higher electrochemical stability than the electrolyte for a rechargeable lithium battery cell according to Comparative Example 1, not including a compound represented by Chemical Formula 1.

Evaluation 2: Cycle-life Characteristic Evaluation of Rechargeable Lithium Battery Cell

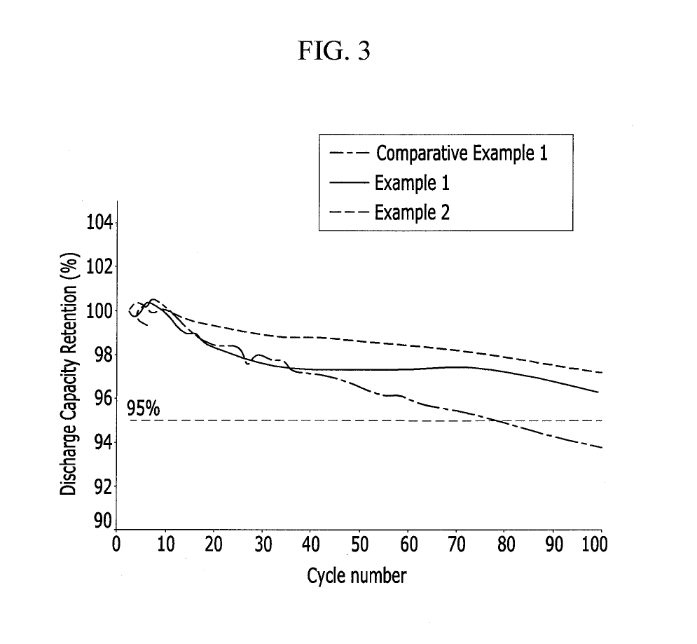

Each rechargeable lithium battery cell obtained from Example 1, Example 2, Example 4, Example 5, Comparative Example 1, and Comparative Example 3 was charged at 1 C and discharged at 1 C (driving voltage: 2.7V to 4.2V) 100 times-and capacity retention was measured. The results are shown in FIG. 3 and Table 1.

In particular, FIG. 3 is a graph showing the capacity retention as a function of cycle number for the rechargeable lithium battery cells according to Example 1, Example 2, and Comparative Example 1.

FIG. shows that the rechargeable lithium batteries according to Example 1 and Example 2 had improved discharge capacity retention compared to the rechargeable lithium battery cell according to Comparative Example 1. Therefore, it is understood that the rechargeable lithium battery cells according to embodiments herein described, have improved cycle-life characteristics.

The results of Example 1, Example 2, Example 4, Example 5, Comparative Example 3 are provided in the following Table 1.

TABLE 1

| | | | | | Comparative |
|---|---|---|---|---|---|
| | Example 1 | Example 2 | Example 4 | Example 5 | Example 3 |
| Capacity | 96 | 97 | 94 | 94 | 92 |
| retention | | | | | |
| (%) | | | | | |
| (100 | | | | | |
| cycles) | | | | | |
| Specific | 153 | 151 | 156 | 155 | 144 |
| discharge | | | | | |
| capacity | | | | | |
| (mAh/g, | | | | | |
| 1^{st} cycle) | | | | | |

As shown in Table 1, the cell according to Comparative Example 3 had low capacity retention and low specific discharge capacity compared with the cells according to Examples 1, 2, 4, and 5. Accordingly, an electrolyte solution had improved cycle-life characteristics when an electrolyte solution including N-phenylpyrrole in an amount ranging from greater than or equal to 0.001 volume % and less than 1 volume % based on the total volume of the non-aqueous organic solvent.

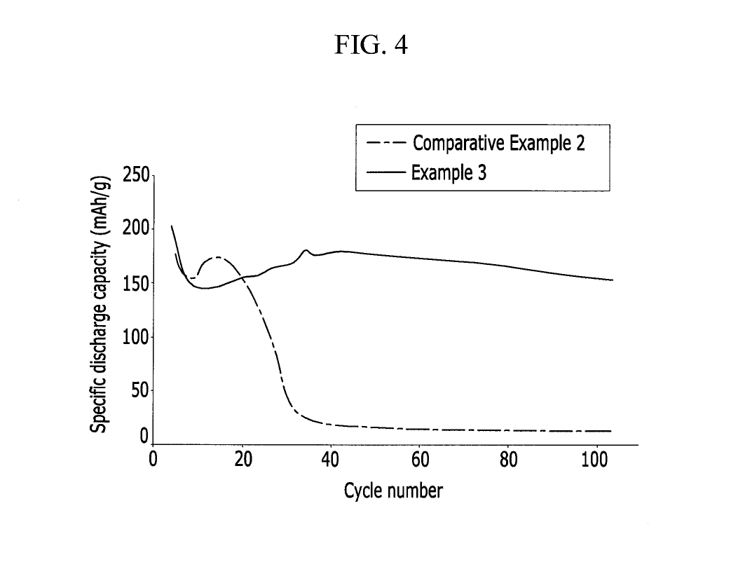

Each rechargeable lithium battery cell obtained from Example 3 and Comparative Example 2 was charged at 1 C and discharged at 1 C (operation voltage: 2.7V to 4.2V) 100 times, and a capacity retention was measured. The results are shown in FIG. 4.

In particular, FIG. 4 is a graph showing the capacity as a function of cycle number for each rechargeable lithium battery cell obtained from Example 3 and Comparative Example 2.

FIG. 4 shows that the rechargeable lithium battery cell according to Example 3 did not show the remarkable deterioration of discharge capacity compared to the rechargeable lithium battery cell according to Comparative Example 2. Therefore, it is understood that the rechargeable lithium battery cell according to embodiments herein described had improved cycle-life characteristics.

Evaluation 3: Storage Characteristic Evaluation of Rechargeable Lithium Battery Cells

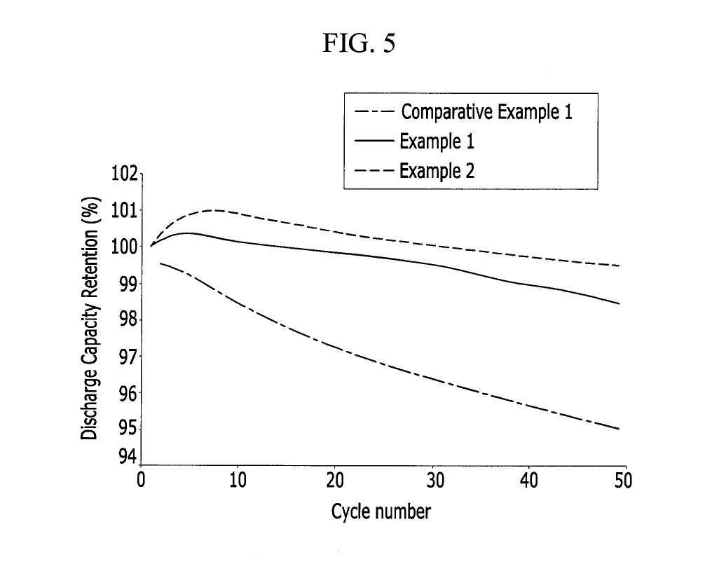

Each rechargeable lithium battery cell obtained from Example 1, Example 2, and Comparative Example 1 was charged at 1 C and discharged at 1 C (operation voltage: 2.7V to 4.2V) 10 times, and after 20 days, the capacity retention was measured. This was repeated every 10 cycles for 50 cycles. The results are shown in FIG. 5.

In particular, FIG. 5 is a graph showing a capacity retention as a function of cycle number for the rechargeable lithium batteries according to Example 1, Example 2, and Comparative Example 1 after being allowed to stand for 20 days.

FIG. 5 shows that the rechargeable lithium batteries according to Example 1 and Example 2 had improved discharge capacity retention after being allowed to stand for 20 days compared to the rechargeable lithium battery cell according to Comparative Example 1. Therefore, it is understood that the rechargeable lithium battery cell according to embodiments herein described had excellent storage characteristics.

Evaluation 4: Coulomb Efficiency Evaluation of Rechargeable Lithium Battery Cell

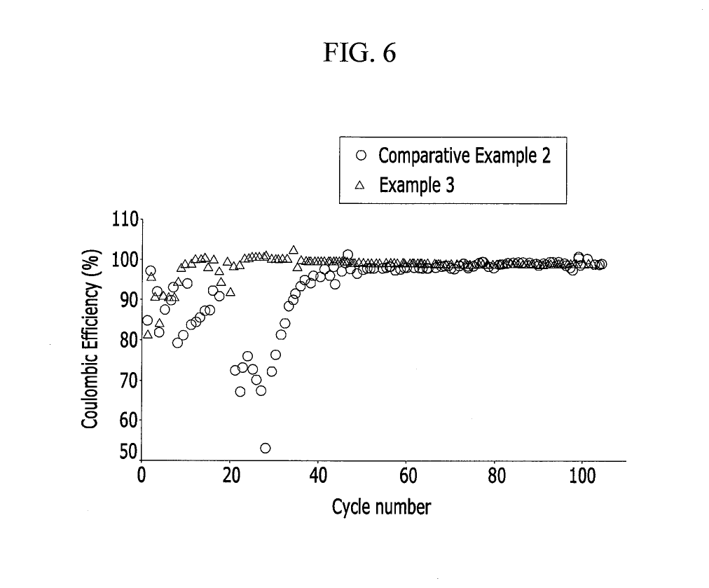

FIG. 6 is a graph showing a coulomb efficiency as a function of cycle number for the rechargeable lithium battery cells according to Example 3 and Comparative Example 2.

FIG. 6 shows that the rechargeable lithium battery cell according to Example 3 including an electrolyte solution of non-aqueous organic solvent including the compound represented by Chemical Formula 1, improved the charge and discharge efficiency compared to the rechargeable lithium battery cell according to Comparative Example 2, including an electrolyte solution which did not include the compound represented by Chemical Formula 1.

Specifically, Comparative Example 2 had higher irreversible capacity at a first forming cycle than that of Example 3 (measured for Initial Coulombic Efficiency (ICE) at 25 C, Comparative Example 2: 85%, Example 3: 82%). However, at the additional charge and discharge cycle performed at 25 C, the battery cell according to Example 3 showed a coulomb efficiency near 100%, which was caused by forming a SEI (solid-electrolyte interface) passivation film on the positive electrode. Additionally, the cycle characteristics of the battery cell according to Comparative Example 2 was less reversible and less stable compared to those of Example 3.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims and equivalents thereof.

What is claimed is:

1. An electrolyte for a rechargeable lithium battery comprising:
a lithium salt; and
a non-aqueous organic solvent comprising a compound represented by Chemical Formula 1, 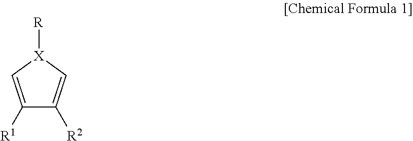
wherein the compound represented by Chemical Formula 1 is included at greater than or equal to 0.001 volume % and less than 1 volume % based on the total volume of the non-aqueous organic solvent, and
wherein, in Chemical Formula 1,
X is nitrogen (N) or sulfur (S),
R¹ and R² are each independently hydrogen (H), a halogen, a cyano group (CN), a nitro group (NO₂), a substituted or unsubstituted C1 to C30 alkyl group, a substituted or unsubstituted C3 to C30 cycloalkyl group, a substituted or unsubstituted C6 to C30 aryl group, a substituted or unsubstituted C2 to C30 alkenyl group, a substituted or unsubstituted C3 to C30 cycloalkenyl group, a substituted or unsubstituted C2 to C30 alkynyl group, a substituted or unsubstituted C3 to C30 cycloalkynyl group, a substituted or unsubstituted C2 to C30 heterocycloalkyl group, a substituted or unsubstituted C2 to C30 heteroaryl group, a substituted or unsubstituted C1 to C30 alkoxy group, or an aldehyde group,
R is a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C20 arylalkyl group, a substituted or unsubstituted C2 to C30 alkenyl group, a substituted or unsubstituted C3 to C30 cycloalkenyl group, a substituted or unsubstituted C2 to C30 alkynyl group, a substituted or unsubstituted C1 to C20 heteroan alkyl group, a substituted or unsubstituted C2 to C30 heterocycloalkyl group, a substituted or unsubstituted C2 to C30 heteroaryl group, —SiR³₃, —NR⁴R⁵, or —PR⁶R⁷, and
R³, R⁴, R⁵, R⁶, and R⁷ are each independently a substituted or unsubstituted C1 to C30 alkyl group, a substituted or unsubstituted C3 to C30 cycloalkyl group, a substituted or unsubstituted C2 to C30 alkenyl group, or a C6 to C30 substituted or unsubstituted aryl group,
wherein the electrolyte does not include a halogen (X′) of the form X′₂ or H—X′.

2. The electrolyte of claim 1, wherein the electrolyte does not include a halogen-containing compound other than that as represented by Chemical Formula 1.

3. The electrolyte of claim 1, wherein, in Chemical Formula 1,
R is a substituted or unsubstituted C6 to C30 aryl group, or SiR³₃, and
R³ is a substituted or unsubstituted C1 to C30 alkyl group, a substituted or unsubstituted C3 to C30 cycloalkyl group, a substituted or unsubstituted C2 to C30 alkenyl group, or C6 to C30 substituted or unsubstituted aryl group.

4. The electrolyte of claim 3, wherein, in Chemical Formula 1, X is nitrogen (N).

5. The electrolyte of claim 3, wherein, in Chemical Formula 1, X is nitrogen (N), R is phenyl, R¹ is hydrogen (H), and R² is hydrogen (H).

6. The electrolyte of claim 3, wherein, in Chemical Formula 1, X is nitrogen (N), R is —Si(CH₃)₃, R¹ is hydrogen (H), and R² is hydrogen (H).

7. The electrolyte of claim 1, wherein the compound represented by Chemical Formula 1 is included at greater than or equal to 0.05 volume % and less than 1 volume % based on the total volume of the non-aqueous organic solvent.

8. A rechargeable lithium battery comprising:
a positive electrode comprising a positive active material;
a negative electrode comprising a negative active material; and
the electrolyte of claim 1.

9. The rechargeable lithium battery of claim 7, further comprising:
a solid electrolyte interphase (SEI) passivation film on the surface of the positive electrode, the SEI passivation film comprising a polymer represented by the following Chemical Formula 2: 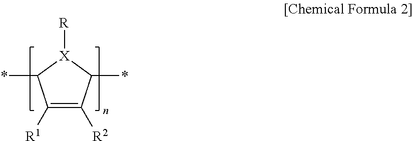
in Chemical Formula 2,
X, R¹, R², and R are the same as in Chemical Formula 1, and
n is an integer of 2 to 1000.

10. The rechargeable lithium battery of claim 8, wherein the positive active material comprises a compound represented by Chemical Formula 3, a compound represented by the following Chemical Formula 4, or a combination thereof
(P)Li₂MnO₃.(1-P)LiNiₐCo_{b}Mn_{c}O₂, [Chemical Formula 3]
in Chemical Formula 3, 0.25<P<0.75, 0.25<a<0.75, 0.1<b<0.5, 0.1<c<0.5, and a+b+c=1,
Li_{d}NiₓCo_{y}Mn_{1-x-y}O₂ [Chemical Formula 4]
in Chemical Formula 4, 0.9≦d<1.1, 0.3≦x≦0.75, and 0.15≦y≦0.4.

11. The rechargeable lithium battery of claim 7, wherein the positive active material comprises a compound represented by Chemical Formula 3, a compound represented by the following Chemical Formula 4, or a combination thereof
(P)Li₂MnO₃.(1-P)LiNiₐCo_{b}Mn_{c}O₂, [Chemical Formula 3]
in Chemical Formula 3, 0.25<P<0.75, 0.25<a<0.75, 0.1<b<0.5, 0.1<c<0.5, and a+b+c=1,
Li_{d}NiₓCo_{y}Mn_{1-x-y}O₂ [Chemical Formula 4]
in Chemical Formula 4, 0.9≦d<1.1, 0.3≦x≦0.75, and 0.15≦y≦0.4.

12. A method of fabricating a rechargeable lithium battery, the method comprising:
obtaining a positive electrode comprising a positive active material and a negative electrode comprising a negative active material;
obtaining the electrolyte of claim 1; and
impregnating the electrolyte into the positive electrode and the negative electrode.

13. An electrolyte for a rechargeable lithium battery comprising:
a lithium salt; and
a non-aqueous organic solvent comprising a compound represented by Chemical Formula 1, 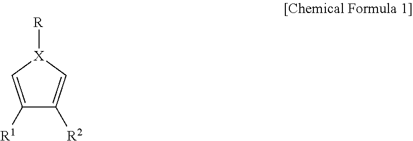
wherein the compound represented by Chemical Formula 1 is included at greater than or equal to 0.001 volume % and less than 1 volume % based on the total volume of the non-aqueous organic solvent, and
wherein, in Chemical Formula 1,
X is nitrogen (N),
R is a substituted or unsubstituted C6 to C30 aryl group, or SiR³₃, and
R³ is a substituted or unsubstituted C1 to C30 alkyl group, a substituted or unsubstituted C3 to C30 cycloalkyl group, a substituted or unsubstituted C2 to C30 alkenyl group, or C6 to C30 substituted or unsubstituted aryl group.

14. The electrolyte of claim 13, wherein, in Chemical Formula 1, X is nitrogen (N), R is phenyl, R¹ is hydrogen (H), and R² is hydrogen (H).

15. The electrolyte of claim 13, wherein, in Chemical Formula 1, X is nitrogen (N), R is —Si(CH₃)₃, R¹ is hydrogen (H), and R² is hydrogen (H).

16. The electrolyte of claim 13, wherein the compound represented by Chemical Formula 1 is included at greater than or equal to 0.05 volume % and less than 1 volume % based on the total volume of the non-aqueous organic solvent.

17. A rechargeable lithium battery comprising:
a positive electrode comprising a positive active material, wherein the positive active material comprises a compound represented by Chemical Formula 3, a compound represented by the following Chemical Formula 4, or a combination thereof
(P)Li₂MnO₃.(1-P)LiNiₐCo_{b}Mn_{c}O₂, [Chemical Formula 3]
in Chemical Formula 3, 0.25<P<0.75, 0.25<a<0.75, 0.1<b<0.5, 0.1<c<0.5, and a+b+c=1,
Li_{d}NiₓCo_{y}Mn_{1-x-y}O₂ [Chemical Formula 4]
in Chemical Formula 4, 0.9≦d<1.1, 0.3≦x≦0.75, and 0.15≦y≦0.4;
a negative electrode comprising a negative active material; and
an electrolyte, the electrolyte comprising
a lithium salt; and
a non-aqueous organic solvent comprising a compound represented by Chemical Formula 1, 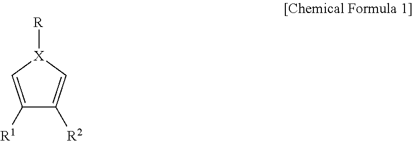
wherein the compound represented by Chemical Formula 1 is included at greater than or equal to 0.001 volume % and less than 1 volume % based on the total volume of the non-aqueous organic solvent, and
wherein, in Chemical Formula 1,
X is nitrogen (N) or sulfur (S),
R¹ and R² are each independently hydrogen (H), a halogen, a cyano group (CN), a nitro group (NO₂), a substituted or unsubstituted C1 to C30 alkyl group, a substituted or unsubstituted C3 to C30 cycloalkyl group, a substituted or unsubstituted C6 to C30 aryl group, a substituted or unsubstituted C2 to C30 alkenyl group, a substituted or unsubstituted C3 to C30 cycloalkenyl group, a substituted or unsubstituted C2 to C30 alkynyl group, a substituted or unsubstituted C3 to C30 cycloalkynyl group, a substituted or unsubstituted C2 to C30 heterocycloalkyl group, a substituted or unsubstituted C2 to C30 heteroaryl group, a substituted or unsubstituted C1 to C30 alkoxy group, or an aldehyde group,
R is a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C20 arylalkyl group, a substituted or unsubstituted C2 to C30 alkenyl group, a substituted or unsubstituted C3 to C30 cycloalkenyl group, a substituted or unsubstituted C2 to C30 alkynyl group, a substituted or unsubstituted C1 to C20 heteroan alkyl group, a substituted or unsubstituted C2 to C30 heterocycloalkyl group, a substituted or unsubstituted C2 to C30 heteroaryl group, —SiR³₃, —NR⁴R⁵, or —PR⁶R⁷, and
R³, R⁴, R⁵, R⁶, and R⁷ are each independently a substituted or unsubstituted C1 to C30 alkyl group, a substituted or unsubstituted C3 to C30 cycloalkyl group, a substituted or unsubstituted C2 to C30 alkenyl group, or a C6 to C30 substituted or unsubstituted aryl group.

18. The rechargeable lithium battery of claim 17, wherein the positive active material comprises LiNi₅Co₂Mn₃O₂.

19. The rechargeable lithium battery of claim 17, wherein the positive active material comprises Li₂MnO₃.

20. The rechargeable lithium battery of claim 17, wherein the compound represented by Chemical Formula 1 is included at greater than or equal to 0.05 volume % and less than 1 volume % based on the total volume of the non-aqueous organic solvent.
